(19) United States
(12) Patent Application Publication
(10) Pub. No.: US 2006/0055629 A1
(43) Pub. Date: Mar. 16, 2006

(54) Ambient light adaptation for dynamic foil displays

(75) Inventor: Roel Van Woudenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS , N.V., EINDHOVEN (NL)

(21) Appl. No.: 10/540,710

(22) PCT Filed: Dec. 4, 2003
(86) PCT No.: PCT/IB03/05715

§ 371 Date: Jun. 24, 2005

(30) Foreign Application Priority Data
Dec. 30, 2002 (EP) 02080571.9

(51) Int. Cl. G09G 3/00

(52) U.S. Cl. 345/30

(57) ABSTRACT

The present invention relates to the driving of optical displays, such as Dynamic Foil Displays, and provides dynamic adaptation of the number of subfields into which frame times of such displays are divided. The number of subfields can thus be selected (1202) depending on for example the ambient light conditions (1201) and image quality requirement. In particular, a smaller number of subfields facilitates brighter images, whereas a larger number of subfields facilitates an increased number of gray scales and/or motion artifact reduction.

The present invention relates to optical displays, such as Dynamic Foil Displays, and in particular to the driving of such displays using subfields.

An optical display is a display in which each pixel independently modulates light from a light source, such as a backlight, a front light, an illumination light, or a light guide, to generate an image.

A Dynamic Foil Display (DFD) typically comprises a display panel having a light guide plate acting as an active plate, a passive plate and a movable foil sandwiched between these plates as well as selection means. The movable foil is arranged with a transparent electrode, to which a foil voltage can be applied. Pixels are typically arranged in a matrix configuration, each pixel being located at the intersection of a horizontal scan electrode arranged on the passive plate and a vertical address electrode arranged on the active plate. Depending on the voltage setup between the scan, address and foil electrodes, electrostatic forces can be created locally forcing the foil either to the active or to the passive plate, resulting in the pixel being either activated or inactivated, respectively. Thus, each pixel is either in an active, light decoupling state or in an inactive, light blocking state, there is no state in-between. In case a pixel is activated, the movable foil is locally brought into contact with the light guide plate and light is consequently decoupled out of the light guide plate into the foil where it scatters out of the display, resulting in a bright pixel. The pixel remains in this active state until it is deactivated, i.e. the contact is interrupted, and vice versa.

A pixel is said to be in an ON-state when the movable foil is locally brought into contact with the light guide, and to be in an OFF-state when the foil is locally in contact with the passive plate. Typically, a display is addressed one row at a time. When designing the addressing scheme for such a display, the time it takes to address, or scan, one row is commonly called a time slot. Thus, the addressing of every pixel in one row needs one time slot. During that time slot, some of the pixels are typically activated into their ON-state while the other pixels are left in their OFF-state. Of course, the duration of the time slot is independent of the number of activated pixels. Similarly, one time slot is needed for erasing a row, i.e. deactivating the pixels. However, the time slot for erasing does not need to have the same duration as the time needed for addressing.

Since the pixels are restricted to be either in an ON-state or in an OFF-state, gray scales are not readily provided for. Thus, in order to create gray scales at pixels, the frame time for each image is divided into a set of subfields. Each subfield comprises an addressing interval, an active interval and an erase interval, each interval having a predetermined duration. In case a pixel is to be active during a particular subfield, it is activated during the activation interval, it decouples light during the active interval and it is deactivated during the deactivation interval. In case the pixel is not to be activated, it is left deactivated during the activation interval and, consequently, does not decouple light during the active interval. Depending on the duration of the active interval, a subfield potentially (in case it is activated) contributes a certain amount of brightness to the image. Typically, the active intervals of a set of subfields have different durations, thus potentially contributing different amounts of light. However, the addressing and erasing intervals are the same for every subfield and thus independent from the duration of the active intervals.

Such a configuration facilitates a large set of gray scale levels to be displayed during a frame time, simply by choosing to activate different combinations of subfields during the frame time. In other words, by displaying all subfields consecutively during one frame time, some of which are active and some of which are inactive, the total fraction of time that light is decoupled during each frame time at a pixel is controlled and gray scales are created. The dullest (and non-zero) gray scale is achieved activating only the subfield having the shortest active interval, and the brightest gray scale is achieved activating all subfields.

A DFD of a general type is known from WO99/28890.

However, the use of subfields in order to provide gray scales is experienced to have certain limitations and drawbacks. For example, it is difficult to provide bright enough images for use in sunshine conditions. Furthermore, when used in dark ambient conditions the number of available gray scales is too limited to provide for the desired image quality. In addition, severe artifacts might affect the image quality. Consequently, there is a need for improved optical display devices in which the above problems are alleviated.

For the purpose of the present invention, it is recognized that a compromise has to be made between the brightness and the quality of the image when operating an optical display. It is furthermore recognized that the critical trade-off factor is the total number of subfields into which each frame time is divided. Basically, a high brightness can be obtained when a low number of subfields are employed, i.e. when the total addressing time (the sum of the activating and deactivating intervals for all subfields in a frame) is low and a large fraction of the frame time can be used for light generation in the active intervals. With a low number of subfields, the image quality is poor, however, due to the occurrence of severe motion artifacts (dynamic false contouring, blur, double images) and/or a limited number of gray levels. When employing a large number of subfields, the number of gray levels can be increased and coding rules can be introduced which results in good image quality. For this purpose, various coding rules are available and well known in the art. However, a larger fraction of the frame time is used for addressing the display and only a limited fraction of the frame time is available for light generation. Thus, the maximum available brightness will be low.

The problems related to subfields are substantially alleviated by the optical display device according to claim 1 and by the method according to claim 7. The appended subclaims provide preferred embodiments of the invention.

Thus, according to a first aspect of the invention an optical electronic information display device is provided which is operative to display images during frame times. The display device is arranged to operate in either one of at least two modes of operation, wherein
in a first mode of operation each frame time is divided into a first number of subfields; and
in a second mode of operation each frame time is divided into a second number of subfields, the second number being larger than the first number. The inventive display device furthermore comprises means for switching between the modes of operation.

For the purpose of the invention, the importance of controlling the number of subfields, thus finding the right balance between for example brightness and other image quality factors, is recognized. Thus, the invention according to claim 1 provides for dynamic adaptation of the number of subfields used for each time frame. Consequently, instead of having to make a final compromise at the time of manufacturing of the device, the number of subfields can be dynamically adapted during the operation of the device. Switching between the different modes of operation can be made manually or automatically.

According to one preferred embodiment the display device comprises an ambient light sensor device and the means for switching is responsive to an output of the sensor device to make the display operate in the first mode of operation when the sensor is exposed to bright ambient conditions and to make the display operate in the second mode of operation when the sensor is exposed to dull ambient conditions.

This embodiment thus facilitates automatic switching between different modes of operation, depending on the ambient light condition. Consequently, the invention provides automatic adaptation of the number of subfields to the amount of ambient light. In a bright environment, it is most important to achieve the maximum brightness, and a limited loss in gray level rendering at the lower gray values is acceptable. In a dull environment, however, the lowest gray values should also be well distinguishable, but the maximum brightness can be reduced. The human visual system has adapted to the dull environment and a reduced maximum brightness is then even preferred.

According to another embodiment, the means for switching is controllable by means of user input. This is advantageous in that it provides manual switching between the different modes of operation. The user can thus choose the mode of operation individually. It is also possible to combine a light sensing function with a user control function, for example by having user input means which, when used, overrides the sensor signal.

According to another embodiment, a larger number of gray scales are provided in the second mode of operation than in the first mode of operation. This is advantageous in that the second mode of operation thus provides for higher image quality.

According to another embodiment, a first set of coding rules are employed in the first mode of operation and a second set of coding rules are employed in the second mode of operation, the first and the second sets of coding rules being different from each other. Thereby, it is possible to dynamically adapt the coding rules to, for example, the ambient light conditions. This is advantageous in that it provides improved image quality. It is, for example, possible to reduce motion artifacts when employing the second mode of operation as compared to the first mode of operation.

According to another embodiment, the first mode of operation provides brighter images than does the second mode of operation. This is advantageous in that the trade-off between image brightness and image quality can be made. For example, the first mode of operation can be used in order to provide bright images in bright ambient conditions, and the second mode of operation can be used in order to provide a larger number of gray scales and/or reduced motion artifacts. Instead of having to make a final selection at the time of manufacturing the device, the number of subfields can be dynamically adapted during the operation of the device.

According to a second aspect of the invention, a method of operating an optical display device that is operative to display images during frame times is provided, comprising the steps of:
selecting a mode of operation from a set of at least two modes of operation, including a first mode of operation in which each frame time is divided into a first number of subfields, and a second mode of operation in which each frame time is divided into a second number of subfields, the second number being larger than the first number;
switching to the selected mode of operation; and
driving the display (displaying the image) using the selected mode of operation.

Thus, the inventive method provides dynamic adaptation of the mode of operation and thus the number of subfields into which each frame time is divided. The method is advantageous in that the mode of operation can be adapted in response to for example varying driving conditions or user input. The different numbers of subfields facilitate the use of for example different coding rules, different number of gray scales and different brightness for a displayed image.

According to one embodiment, the method further comprises the step of:
determining a level of ambient light, and the step of selecting a mode of operation depends on the determined level of ambient light.

Preferably, a mode of operation using a smaller number of subfields is selected for high levels of ambient light and a mode of operation using a higher number of subfields is selected for low levels of ambient light. The ambient light level can be determined by means of an ambient light sensor, which provides a control signal to driver circuitry of the display. This is advantageous in that the adaptation to different ambient light levels can be performed automatically.

According to one embodiment, the step of selecting a mode of operation depends on a trade-off between required brightness for the image and a number a gray scales for the image. If a large number of gray scales has priority, a larger number of subfields is selected, whereas a smaller number of subfields is selected if a high brightness has priority.

Thus, the basic idea underlying the present invention is the insight that the number of subfields can be adapted dynamically in order to adapt the optical display to different driving conditions. The dynamic adaptation is preferably based on a tradeoff between factors such as preferred image brightness, preferred number of gray scales and preferred coding rules. In particular, a reduced number of subfields facilitates brighter images, whereas an increased number of subfields facilitates an increased number of gray scales and/or image quality enhancing coding rules.

These and other aspects of the invention will be apparent from and elucidated with reference to the embodiments described hereinafter.

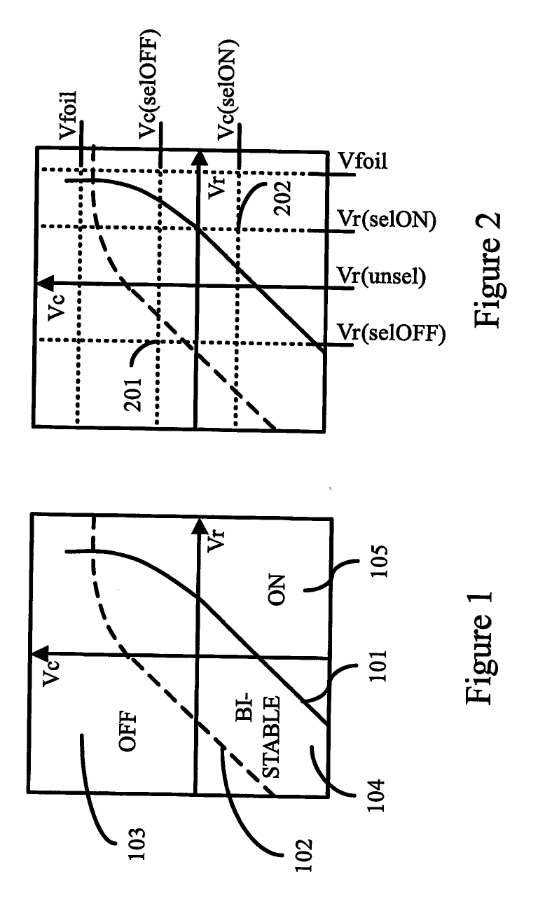

FIG. 1 illustrates three different voltage regions for a bistable DFD pixel: the ON-region, the bistable region and the OFF-region.

FIG. 2 illustrates different row (x-axis) and column (y-axis) electrode voltage levels for a typical DFD addressing scheme.

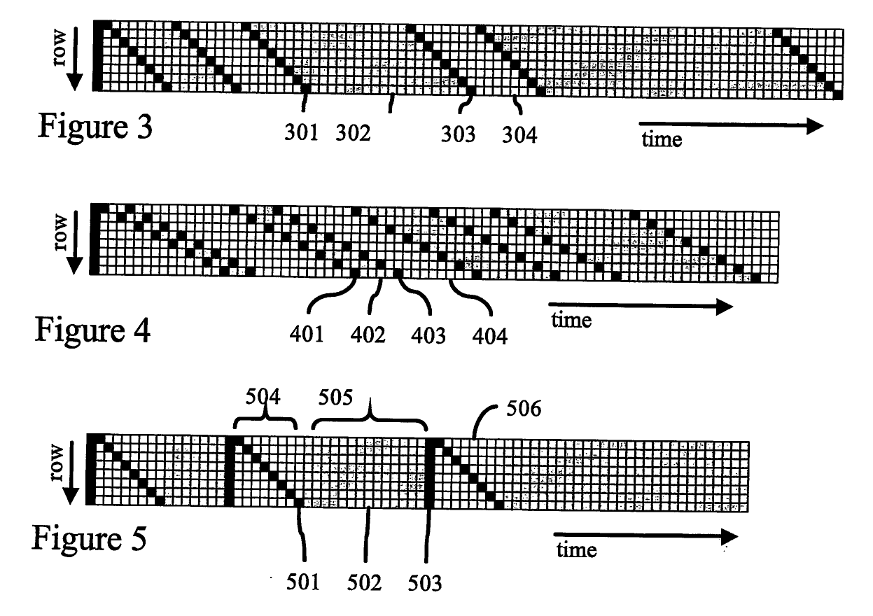

FIGS. 3, 4 and 5 illustrates different DFD addressing schemes.

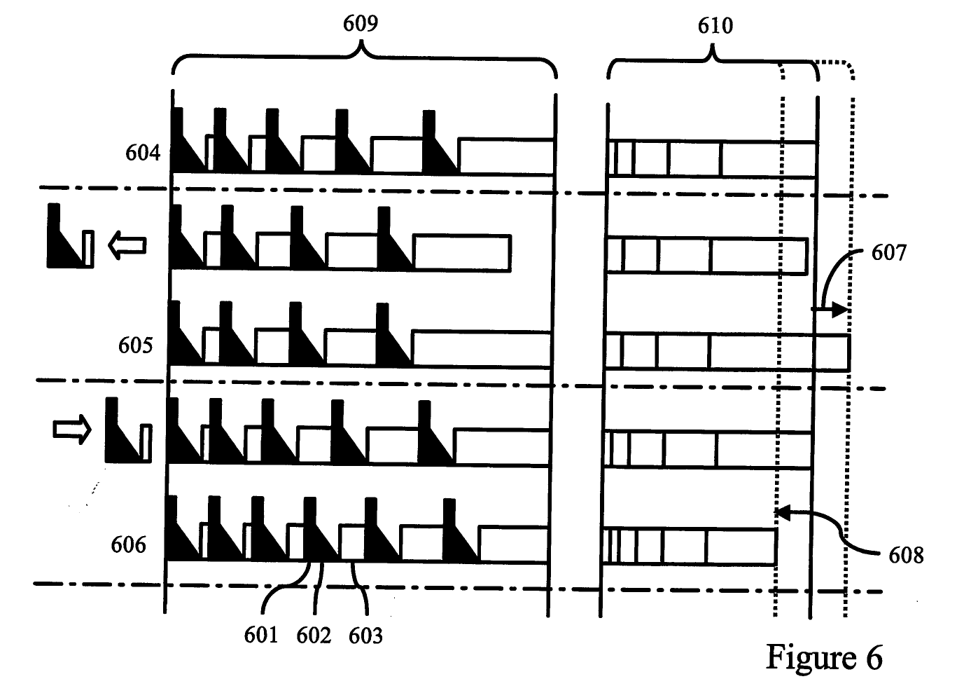

FIG. 6 illustrates how the duration of active intervals depends on the number of subfields.

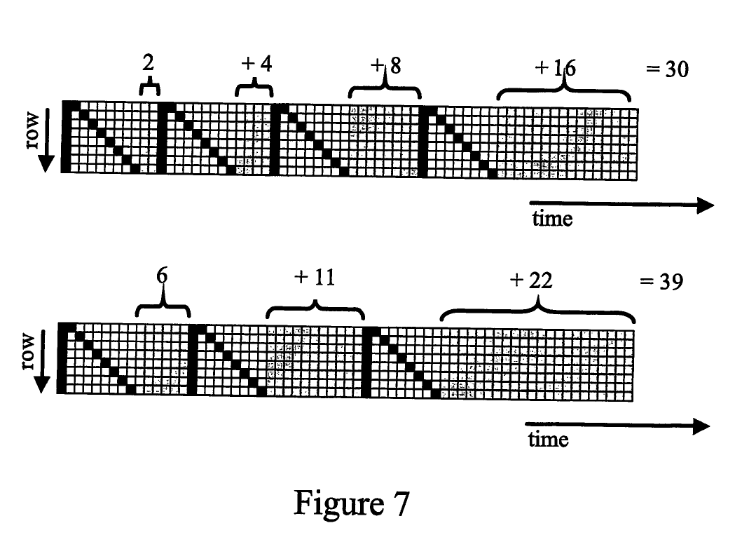

FIG. 7 illustrates different active intervals for a Flash Light operated addressing scheme.

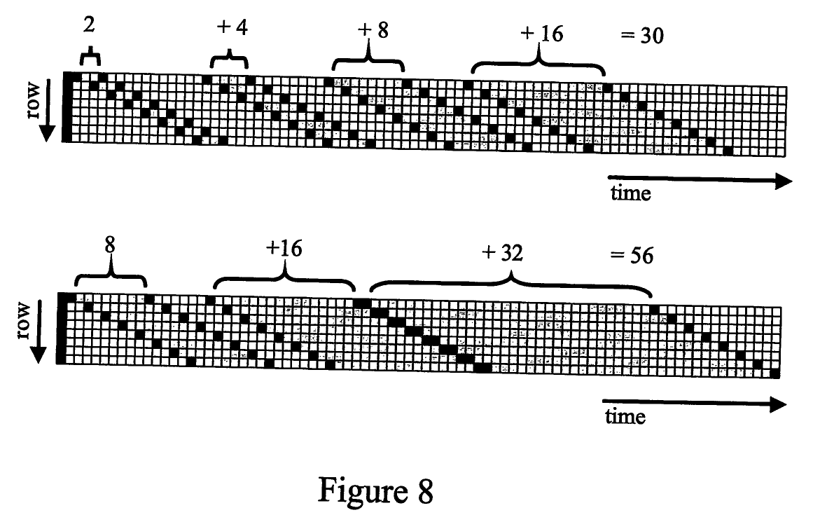

FIG. 8 illustrates different active intervals for an Address-While-Display operated addressing scheme.

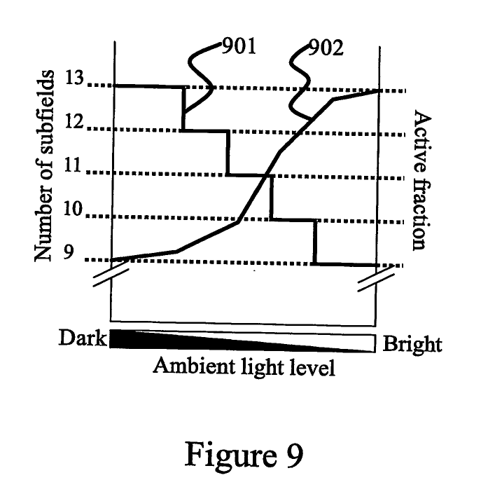

FIG. 9 illustrates one possible relationship between the number of subfields and the level of ambient light.

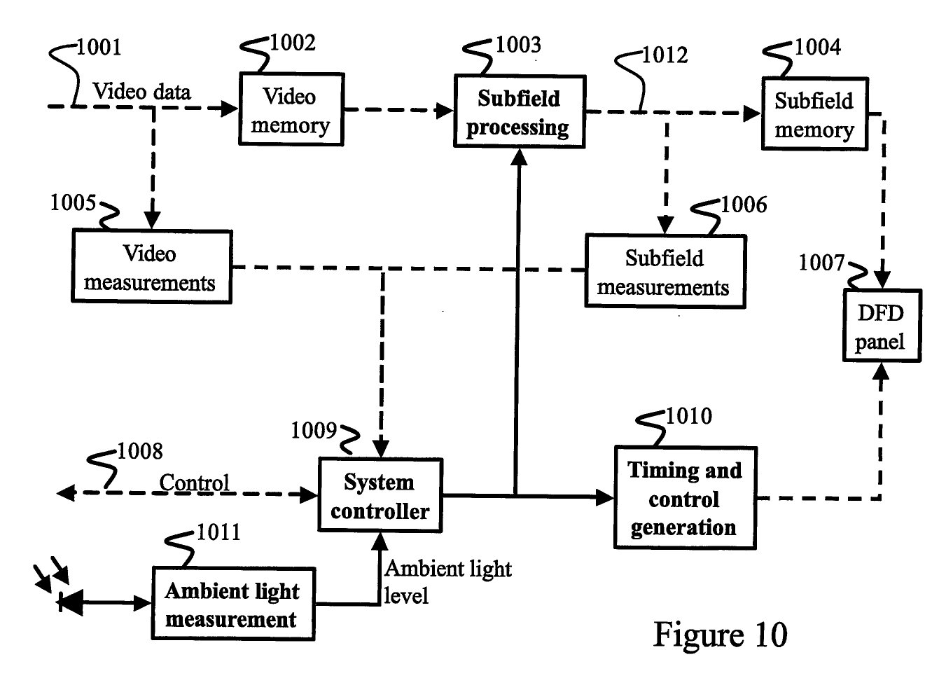

FIG. 10 is a block diagram illustrating an inventive DFD driving circuitry.

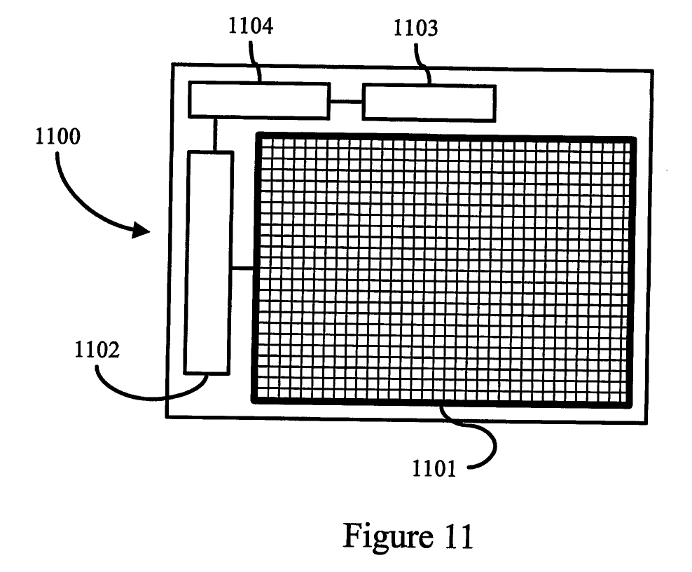

FIG. 11 schematically illustrates an embodiment of a DFD comprising means for switching between modes of operation.

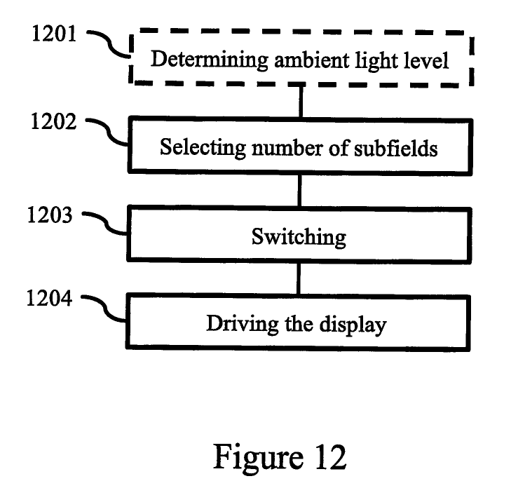

FIG. 12 is a block diagram illustrating an embodiment of the inventive method.

FIG. 11 schematically illustrates an embodiment of an inventive dynamic foil display 1100. The display 1100 comprises driving circuitry 1102 for driving a display panel 1101, means 1104 for switching between modes of operation and a sensor 1103 for sensing an ambient light level. The means 1104 for switching is interconnected with the sensor 1103 and the driving circuitry 1102.

The driving of a Dynamic Foil Display relies on bistability or hysteresis. The pixels are addressed by means of a voltage applied to a row electrode and a column electrode related to the pixel. The voltage applied to the electrodes can be classified in three different regions, an ON-region, in which the pixel is urged to its ON-state, an OFF-region, in which the pixel is urged to its OFF-state, and an intermediate, bistable region, in which the pixel remains in its current state. FIG. 1 diagrammatically shows the relative voltages that can be applied to a pixel. The x-axis corresponds to the row electrode voltage (Vr), the y-axis corresponds to the column electrode voltage (Vc), and the intersection of the axes corresponds to zero voltage. Also the foil voltage level is indicated. The voltage differences between the foil and the respective electrodes determines the electrostatic force F between the foil electrode and the row and column (passive and active plate), respectively, because the force F is proportional to the squared voltage difference (dV) and inversely proportional to the distance d between the two electrodes: F∝(Vr−Vfoil)²/d (Vc−Vfoil)²/d, respectively. The balance of forces determines the position of the foil: For certain combinations of voltages applied to the column and the row, a pixel will be put in the ON-state (voltage region 105, the ON-region), i.e. the foil will be urged to contact the light guide. In voltage region 103, the OFF-region, the foil will instead be urged to contact the other, passive plate and the pixel will hence be put in the OFF-state. However, in a voltage region 104, the bistable region, the force on the foil caused by the voltage is insufficient to switch the foil, and the pixel will remain in its current state. The boundaries between the regions are known as the ON-curve, 101, and the OFF-curve, 102.

There are two different principles on which the driving of optical displays can be based. Either a so-called Address-Display-Separated or Flash Light principle is employed, or a so-called Address-While-Display principle is employed. In case an Address-While-Display mode of operation is employed, the light guide is always carrying light and the pixels are thus always emitting light when they are in their ON-state. Such addressing schemes are illustrated in FIGS. 3 and 4, for displays having 8 rows. FIG. 3 illustrates rows being addressed according to a so-called LSB (Least Significant Bit) scheme and FIG. 4 illustrates rows being addressed according to a so-called Compact Smooth scheme. Squares 301 and 401, respectively, indicate time slots when rows of pixels are addressed. A row is addressed by scanning the pixels in it and turning the relevant pixels, if any, to their ON-state. Squares 302 and 402, respectively, indicate time slots when rows are active, i.e. when the relevant pixels, if any, are in their ON-state. Squares 303 and 403, respectively, indicate time slots when rows are erased, i.e. every pixel is forced to its OFF-state. Squares 304 and 404, respectively, indicate time slots when rows are inactive, i.e. every pixel is in its OFF-state. Since the light guide is always active, a pixel will emit light as soon as it is put in its ON-state, and continue doing so until it is returned to its OFF-state.

In case an Address-Display-Separated or Flash Light mode of operation is employed, the light guide is turned off during the addressing intervals and turned on only during active ON intervals. Such an addressing scheme is illustrated in FIG. 5, where squares 501 indicate time slots where a row is addressed, squares 502 indicate time slots where a row is active and squares 503 indicate time slots where a row is erased. However, during OFF intervals 504 the light guide is switched off, and hence the pixels are unable to emit light. Consequently, there are time slots 506 when a pixel might be in its ON-state, but still does not emit light. Only during ON intervals 505, when the light guide is turned on, are the pixels able to emit light.

An exemplifying addressing scheme for a Flash Light mode of operation is now described with reference to FIG. 2. First, all pixels are erased, i.e. forced to their OFF-state, by applying a foil voltage to the column electrodes. Thereafter one row at a time is put to the ON-select voltage (Vr(selON)), at which voltage the pixels will switch to the light guide (i.e. to the ON-state) if the column voltage is put to Vc(selON) and remain in its current position (i.e. in the OFF-state) when the column voltage is Vc(selOFF). The remaining rows are kept at the unselect voltage (Vr(unsel)), which is selected such that the corresponding pixels remain in their current state (i.e. in the OFF-state) independent of the data voltage applied to the column electrode. Thus, by addressing the column electrodes sequentially the pixels in the selected row are addressed while the remaining rows are left unaffected. In order to address all pixels, the procedure is repeated for each row.

Gray scales are made up by the appropriate combination of binary weighted subfields (BWS), or using subfields with other weights for improved (moving) image quality. The subfields are organized in an addressing scheme, which describes in what order the rows are being addressed with ON and OFF addressing actions. At each addressing slot, one row is being addressed while all other rows are kept at the “unselect” level (in which they stay in their current state). In an Address-While-Display scheme, the light in the light guide is always kept on, and the effect of ON- and OFF-addressing on the pixel's light output is immediate.

FIG. 6 illustrates the general idea of dynamic adaptation of the number of subfields. Sectors 601 refer to erase intervals, sectors 602 refer to address intervals and sectors 603 refer to active intervals. Sequence 604 illustrates a frame time 609 divided into 5 subfields and resulting in a total active interval 610 of a certain length. Sequence 605 illustrates a frame time 609 divided into only 4 subfields. The remaining active intervals can thus be extended, resulting in a total active interval 610 that is lengthened by an interval 607 as compared with sequence 604. Sequence 606 finally illustrates a frame time 609 divided into 6 subfields. The active intervals thus have to be shortened by an interval 608, resulting in a total active interval 610 that is shorter than for sequence 604.

As a first example, the invention can be implemented on a Flash-Light-operated DFD with 500 lines. Thus, consider such a display that needs 1.5 ms to address one subfield (0.25 ms for erasing, plus 500 rows times 2.5 μs of addressing time per row). When 10 subfields are used in a 20 ms video field period, 15 ms is needed for addressing and only 5 ms are left for light generation. At high ambient light, the lowest-weighted subfield corresponds to a luminance contribution that is not (or hardly) visible: it is thus possible to drop this subfield and use only 9 subfields. Then 13.5 ms are needed for addressing and 6.5 ms are available for light generation: this allows an increase of brightness of 30%. In a dark environment however, 11 or even 12 subfields are preferred, resulting in a reduction of brightness of 30% (3.5 ms light generation) or 60% (2 ms light generation) respectively, but then the lowest gray level and the gray level resolution (step size) can be reduced by a factor of approximately 2 or 4, respectively. This example is shown schematically in FIG. 7, where a frame time is divided into three and four subfields, respectively. When dividing the frame time into four frame times, 2+4+8+16=30 time slots are available for light generation. When dividing the frame time into only three subfields, 6+11+22=39 time slots are available. Of course, the duration of the individual active intervals can be altered, but they will always sum up to 39 time slots.

As a second example, illustrated in FIG. 8, the invention can be implemented on a Compact Smooth addressed display with 8 rows, binary weighted subfields and a lowest-weighted subfield of 2 time slots. For 4 subfields this results in a peak brightness corresponding to a light generation during 2+4+8+16=30 time slots. When only 3 subfields are used, the total light generation time increases to 8+16+32=56 time slots with (approximately) the same total time for the whole addressing scheme.

As previously discussed, an ambient light sensor can be used to facilitate automatic, dynamic adaptation of the number of subfields. FIG. 9 illustrates how the number of subfields can depend on the ambient light level. On the extreme left of the diagram the ambient light is at its darkest, and on the extreme right it is at its brightest. Curve 901 indicates the number of subfields as a function of the ambient light level. In this particular example, 13 subfields are used in the darkest conditions and only 9 subfields are used in the brightest conditions. Curve 902 indicates the relative fraction of active intervals, i.e. it is a measure for the maximum available brightness for the display.

The driving of a DFD panel 1007 is schematically illustrated with a block diagram in FIG. 10. Thus, video data 1001 is applied via a video memory to a subfield processing unit 1003, which converts the data to subfield data 1012 that in turn is forwarded via a subfield memory 1004 to the DFD panel 1007. Video measurements 1005 and subfield measurements 1006 are performed on the video data 1001 and the subfield data 1012, respectively, and the measurements are sent to a system controller 1009. The system controller controls the mode of operation, i.e. the number of subfields to be used, depending on an ambient light level signal from an ambient light measurement 1011. In addition, or alternatively, the mode of operation can depend on a control signal 1008, which for example may be a user input signal. The system controller 1009 sends a control signal to the subfield processing unit 1003, containing information about the specific subfield setup to be used, and a timing and control generation signal 1010 to the DFD panel 1007. The control signal thus facilitates coordination of the subfield processing unit 1003 with the timing and control generation signal 1010. The coordinated subfield memory signal is applied to the DFD panel 1007 by the subfield memory unit 1004.

FIG. 12 is block diagram, illustrating an embodiment of the inventive driving method. Firstly, the ambient light level is determined 1201. Secondly, a mode of operation (including a number of subfields) is selected 1202. Thirdly, the display is switched 1203 to the selected mode of operation. Finally, the display is driven 1204 using the selected mode of operation. However, the first step of determining 1201 the ambient light level is optional, and might be neglected.

The present invention can be applied to various types of subfield-driven displays that are based on binary modulation such as, notably:

1. Micro-mechanical optical systems, such as:—Digital Mirror Devices (MD, DLP);
IRIDIGMs Digital Paper display;
Other micro-electromechanical systems (MEMS), such as Grating Light Valve displays, when driven with subfields.

2. Subfield-driven reflective or transmissive LCDs.

Furthermore, the invention can be implemented on sub-line driven displays (e.g. using Pulse-Width Modulation schemes) in which case each row is addressed using subfields, but only one row at a time is activated.

In conclusion, the present invention relates to the driving of optical displays, such as Dynamic Foil Displays, and provides dynamic adaptation of the number of subfields into which frame times of such displays are divided. The number of subfields can thus be adapted depending on for example the ambient light conditions and image quality requirement. In particular, a smaller number of subfields (605) facilitates brighter images, whereas a larger number of subfields (606) facilitates an increased number of gray scales and/or motion artifact reduction.

1. An optical electronic information display device (1100), operative to display images during frame times (609), characterized in that it is arranged to operate in either one of at least two modes of operation, wherein
in a first mode of operation (605) each frame time is divided into a first number of subfields; and
in a second mode of operation (606) each frame time is divided into a second number of subfields, the number of subfields in the second mode of operation (606) being larger than the number of subfields in the first mode of operation (606), and in that it comprises means for switching (1104) between the first and second modes of operation.

2. An optical display device (1100) according to claim 1, further comprising an ambient light sensor (1103) device, wherein said means for switching (1104) is responsive to an output of said sensor device to make the display operate in the first mode of operation when the sensor is exposed to bright ambient conditions and to make the display operate in the second mode of operation when the sensor is exposed to dark ambient conditions.

3. An optical display device (1100) according to claim 1, in which said means for switching (1104) is controllable by means of user input.

4. An optical display device (1100) according to claim 1, in which a larger number of gray scales are provided in the second mode of operation (606) than in the first mode of operation (605).

5. An optical display device (1100) according to claim 1, in which a first set of coding rules are employed in the first mode of operation (605) and a second set of coding rules are employed in the second mode of operation (606), the first and the second set of coding rules being different from each other.

6. An optical display device (1100) according to claim 1, the first mode of operation (605) providing for brighter images than does the second mode of operation (606).

7. An optical display device (1100) according to claim 1, the display device being a dynamic foil display.

8. A method of operating an optical display device (1100) which is operative to display images during frame times (609), comprising the steps of:
selecting (1202) a mode of operation from a set of at least two modes of operation, including a first mode of operation (605) in which each frame time is divided into a first number of subfields, and a second mode of operation (606) in which each frame time is divided into a second number of subfields, the number of subfields in the second mode of operation being larger than the number of subfields in the first mode of operation;
switching (1203) to the selected mode of operation; and
driving (1204) the display using the selected mode of operation.

9. A method according to claim 8, further comprising the step of:
determining (1201) a level of ambient light,
and wherein the step of selecting a mode of operation depends on the determined level of ambient light.

10. A method according to claim 8, wherein the step of selecting (1202) a mode of operation is performed depending on a trade-off between brightness and a number a gray scales for the image.

11. A method according to claim 8, wherein a first set of coding rules are employed in the first mode of operation (605) and a second set of coding rules are employed in the second mode of operation (606), the first and the second set of coding rules being different from each other.

12. A method according to claim 8, wherein the display device (1100) is a dynamic foil display.
